(19) United States
(12) Patent Application Publication
(10) Pub. No.: US 2023/0024817 A1
(43) Pub. Date: Jan. 26, 2023

(54) MITIGATION OF VEHICLE SOFTWARE MANIPULATION

(71) Applicant: Robert Bosch GmbH, Stuttgart (DE)

(72) Inventors: Felix Hallaczek, Stuttgart (DE); Manuel Jauss, Wissgoldingen (DE); Marcel Kneib, Ingelheim (DE); Mustafa Kartal, Renningen (DE)

(21) Appl. No.: 17/860,885

(22) Filed: Jul. 8, 2022

(30) Foreign Application Priority Data
Jul. 14, 2021 (DE) 10 2021 207 473.1

(51) Int. Cl. G06F 21/52; G06F 8/65

(52) U.S. Cl. CPC G06F 21/52; G06F 8/65; G06F 2221/033

(57) ABSTRACT

A computer-implemented method which identifies the possibility of manipulation of the software of a first component of a plurality of components of an on-board network of a vehicle in a central device for mitigating software manipulation. A central device for mitigating manipulation is designed to mitigate software manipulation in each of the plurality of components in the on-board network. The method includes initiation of a countermeasure for mitigating manipulation of the first component by the central device for detecting and mitigating manipulation.

### BACKGROUND INFORMATION

Vehicles have in recent times increasingly been integrated into open contexts (i.e., the vehicles have one or more interfaces via which data are received and/or sent during operation which are in turn used for vehicle operation). In addition, the components of vehicles and in particular their software are becoming increasingly complex.

As a consequence, possibilities for manipulating the software of the vehicle components are becoming more diverse.

In some related art methods, the detection and above all mitigation (i.e., remediation such that a defined (safe) state is obtained) of manipulation is associated with considerable effort and thus time delay. For example, the manipulated software of a component (e.g., of a control unit) can be reset, so remedying the manipulation, during a workshop visit. In other techniques, software can be requested from a remote computer system, which is used to reset the manipulated software of a component (e.g., of a control unit), so remedying the manipulation. In both cases, a considerable period of time may elapse between detection of the manipulation and mitigation of the manipulation. Under certain circumstances, vehicle operation is disrupted during this period of time (e.g. a predetermined safety criterion is no longer met). In some cases, the vehicle may no longer be roadworthy or its functionality greatly impaired. Improved techniques for mitigating software manipulation are therefore desirable.

### SUMMARY

A first general aspect of the present invention relates to a computer-implemented method which includes identifying the possibility of manipulation of the software of a first component of a plurality of components of an on-board network of a vehicle in a central device for mitigating software manipulation. The central device for mitigating manipulation is part of the on-board network and is designed to mitigate software manipulation in each of the plurality of components in the on-board network. The method furthermore comprises initiation of a countermeasure for mitigating manipulation of the software of the first component by the central device for mitigating manipulation.

A second general aspect of the present invention relates to a central device for mitigating manipulation of the software of a plurality of components of an on-board network of a vehicle.

A third general aspect of the present invention relates to an on-board network for a vehicle which comprises the central device for mitigating software manipulation according to the second general aspect and a plurality of components of the on-board network.

A fourth general aspect of the present invention relates to a vehicle which comprises the on-board network according to the third general aspect.

The techniques of the first through fourth general aspects of the present invention may in some cases have one or more of the following advantages.

Firstly, in comparison with related art techniques, it is in some cases possible to reduce, in some situations dramatically reduce, a period of time until manipulation is mitigated. The central device for mitigating manipulation can, as part of the on-board network, immediately (e.g., within five minutes or within one minute) initiate the mitigation procedures (e.g., substantially without the assistance of systems external to the vehicle). In some examples, the central device for mitigating manipulation can not only initiate but also perform the countermeasure. In other examples, other components of the on-board network may (also) be involved in performing the countermeasure. As a consequence, the mitigation procedures can likewise be performed immediately (e.g. within five minutes or within one minute) and the vehicle placed in a defined state (e.g., in a safe state according to a predetermined safety criterion).

Secondly, the techniques of the present invention may be more resource-efficient than other approaches. A central device for mitigating manipulation may accordingly replace a plurality of devices, each of which covers only a proportion of the components. In addition, in some cases components which are already present may be reused for the techniques of the present invention. For example, a persistent memory which is (also) used for updating the software (e.g., for storing a large update package) of the plurality of the vehicle's components may be “reused” to reset the software of a component and so remedy the manipulation. In some cases, there is thus no need to provide a new memory for this purpose. Keeping the software on hand for resetting in each of the plurality of components considerably increased the design effort involved for these components (e.g., control units).

Thirdly (and in part as a consequence of the first aspect), the central device as part of the on-board network can select suitable countermeasures for mitigating manipulation on a context-sensitive basis (i.e., taking account of a current vehicle operating state and/or predetermined rules). For example, information about a vehicle operating state may be taken into account on selection of a countermeasure. This can further assist in shortening the period of time until the vehicle has been placed in a defined state and the manipulation remedied. For example, a first countermeasure may be provided when the vehicle is in motion, while a second, different countermeasure is provided when the vehicle is stationary.

Fourthly, in comparison with some related art techniques, the techniques of the present invention can be more readily scaled and/or used in older vehicles (which are not designed to the latest standard). For example, the central device for mitigating manipulation can be relatively easily modified to “support” additional components. In some cases, the “supported” components require little or no modification for this purpose, so facilitating use in older vehicles. The central device for mitigating manipulation may itself in some cases be retrofitted by a software update. For example, an existing vehicle component (e.g., a central communication interface of the vehicle or a central computer of the vehicle) may be provided with the (additional) function of a central device for mitigating manipulation by way of a software update.

Some terms are used in the present disclosure as follows:

A “component” (of an on-board network) in the present disclosure has its own hardware resources which comprise at least one processor for executing instructions and memory for storing at least one software component. The term “processor” also comprises multi-core processors or a plurality of separate components which assume (and optionally share) the tasks of a central processing unit of an electronic device. A component can carry out tasks autonomously (e.g. measurement tasks, monitoring tasks, control tasks, communication tasks and/or other work tasks). A component may, however, in some examples also be controlled by another component. A component can be physically delimited (e.g. with its own housing) or alternatively be integrated into a higher-level system. A component may be a control unit or a communication unit of the vehicle. A component may be an embedded system.

An “embedded system” is a component which is integrated (embedded) into a technical context. The component here assumes monitoring or open- or closed-loop control functions and/or is responsible for a form of data or signal processing.

A “(dedicated) control unit” is a component which (exclusively) controls a vehicle function. A control unit may for example assume control of an engine/motor, a braking system or an assistance system. A “function” can be defined at different levels of the vehicle (e.g. an individual sensor or actuator can be used for a function, but so too can a plurality of assemblies which are combined to form a larger functional unit).

The term “software” or “software component” may be any part of the software of a component (e.g., a control unit) of the present disclosure. In particular, a software component may be a firmware component of a component of the present disclosure. “Firmware” is software which is embedded in (electronic) components where it performs basic functions. Firmware is functionally fixedly connected to the respective hardware of the component (such that one cannot be used without the other). It can be stored in a nonvolatile memory such as a flash memory or an EEPROM.

The term “update information” or “software update information” comprises any data which, directly or after appropriate processing steps, form a software component of a component according to the present disclosure. The update information may contain executable code or code which is yet to be compiled.

In the present disclosure, the term “manipulation” comprises any modification of software of a vehicle component. The modification may be the result of an attack (i.e. the deliberate influence of a third party), but it may also be the result of a random or unintentional effect.

The term “vehicle” comprises any devices which transport passengers and/or freight. A vehicle may be motor vehicle (e.g. a car or a truck), but also a rail vehicle. Floating and flying devices may, however, also be vehicles. Vehicles may be at least semiautonomously operated or assisted.

An “on-board network” may be any internal network of a vehicle via which the vehicle components communicate. In some examples, an on-board network is a short-range network. An on-board network may use one or more short-range communication protocols (e.g. two or more short-range communication protocols). The short-range communication protocols may be wireless or wired communication protocols. The short-range communication protocols may comprise a bus protocol (e.g. CAN, LIN, MOST, FlexRay or Ethernet). The short-range communication protocols may comprise a Bluetooth protocol (e.g. Bluetooth 5 or later) or a WLAN protocol (e.g., a protocol of the IEEE-802.11-family, e.g. 802.11h or a later protocol). An on-board network may contain interfaces for communication with systems external to the vehicle and thus also be integrated into other networks. The systems external to the vehicle and the other networks are, however, not part of the on-board network.

The expression “identifying a possibility . . . ” indicates that specific circumstances (e.g. signals or their absence) are interpreted according to predetermined rules in order to identify a state in which software manipulation may occur.

### BRIEF DESCRIPTION OF THE DRAWINGS

FIG. 1 is a flow diagram illustrating techniques of the present invention.

FIG. 2 shows components of an on-board network of a vehicle in which the techniques of the present invention can be used.

FIG. 3 shows the on-board network according to FIG. 2 in which a first component has been manipulated.

FIG. 4 shows the on-board network according to FIG. 2 in which the manipulation of the first component has been remedied.

### DETAILED DESCRIPTION OF EXAMPLE EMBODIMENTS

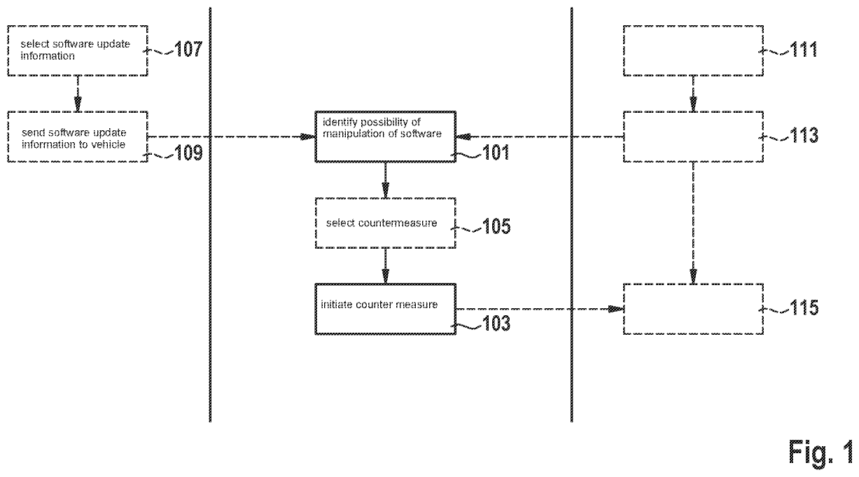

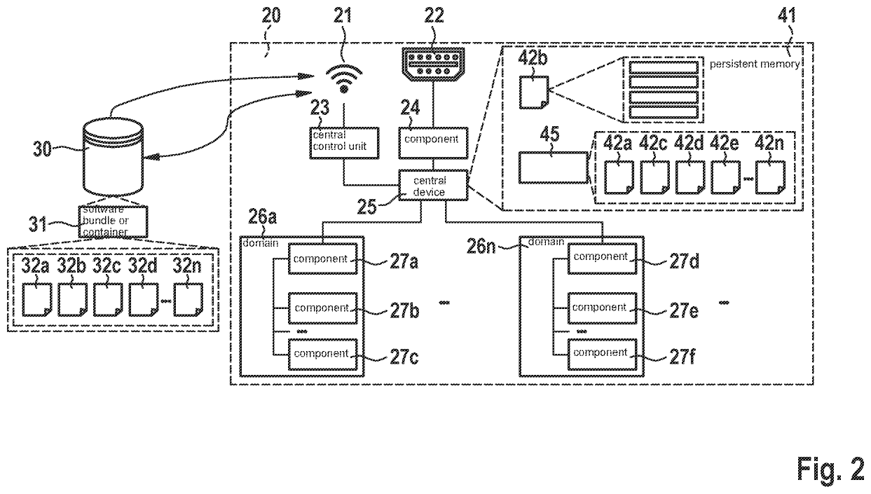

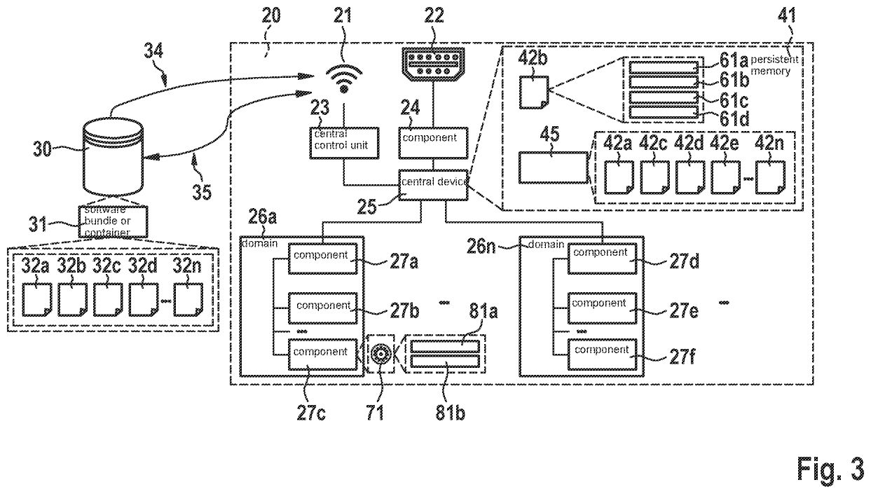

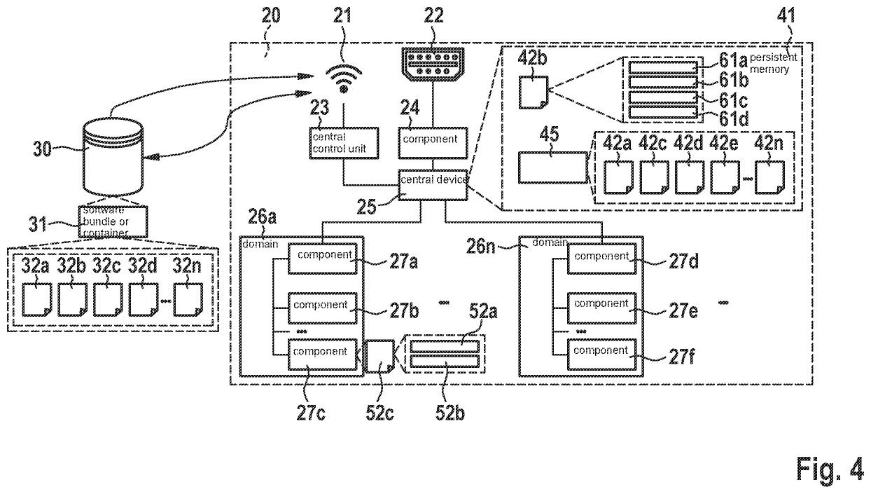

A vehicle in which the techniques of the present invention can be performed and the fundamental aspects of the techniques of the present invention are firstly discussed with reference to FIG. 1 and FIG. 2. Further aspects of the present invention are subsequently explained on the basis of FIG. 3 and FIG. 4.

FIG. 1 is a flow diagram illustrating the techniques of the present invention. FIG. 2 shows components of an on-board network of a vehicle in which the techniques of the present invention can be used.

The middle column of FIG. 1 shows the steps which are performed by a central device for mitigating software manipulation. The right-hand column shows steps which are carried out by a specific component (or a group of components) of the on-board network (exclusively the central device for mitigating software manipulation). The left-hand column shows steps which are performed by a remote system (i.e., external to the vehicle).

The techniques of the present invention comprise identifying 101 the possibility of manipulation of the software of a first component of a plurality of components of an on-board network of a vehicle 20. A vehicle 20 is shown diagrammatically in FIG. 2. The vehicle is equipped with an on-board network which connects a plurality of components 21-24, 25 and 27a-f of the vehicle 20 (the on-board network may be constructed as described above).

The vehicle 20 has a central device 25 for mitigating software manipulation which identifies the possibility of manipulation. Said device is thus part of the on-board network (i.e. also part of the vehicle and moved with it). The central device 25 for mitigating software manipulation is designed for mitigating manipulation of the software in each of the plurality 21-24 and 27a-f of components of the on-board network.

In some examples, the central device 25 for mitigating software manipulation is integrated into a central communication interface of the vehicle 20. The central communication interface may be designed to act as a data distributor for communication within the vehicle 20 and/or with the outside world via a communication interface 21, 22. The central communication interface can support various communication protocols (for communication in the on-board network or with external systems) and/or implement security functions. In other examples, the central device for mitigating software manipulation may be integrated into other components (further examples follow below) or be designed as a standalone component.

In some examples, identifying may involve receiving a signal which indicates manipulation of the software of a first component of a plurality of components of an on-board network of a vehicle 20. The signal may be generated in the central device 25 for mitigating software manipulation itself and/or another device.

Additionally or alternatively, identifying may involve identifying an absence of an (expected) signal (e.g., from the first component or a component which monitors the first component). The on-board network may be designed such that the plurality of components 21-24, 25 and 27a-f or other components send signals which indicate that there has been no manipulation of the software of the respective component of the plurality of components 21-24, 25 and 27a-f (e.g., periodically or on the occurrence of specific events such as a component starting up).

Further additionally or alternatively, identifying may involve processing other status information of the on-board network in order to identify the possibility of manipulation of the software of the first component.

In response to identifying the possibility of manipulation of the software of a first component of a plurality of components of an on-board network of a vehicle 20 (e.g., receiving a signal or identifying the absence of a signal), the central device 25 for mitigating software manipulation initiates a countermeasure for mitigating manipulation of the first component.

The example of FIG. 2 shows a central device 25 for mitigating software manipulation. In some cases, the vehicle may contain only one central device 25 for mitigating software manipulation which is designed for mitigating manipulation of the plurality of components 21-24 and 27a-f (e.g. all the components of a vehicle for which software manipulation can be remedied or a subset of these components). In other examples, a vehicle may have a plurality of central devices for mitigating software manipulation which are part of the on-board network and are in each case associated with a plurality of the components of the on-board network (i.e., are capable of remedying manipulation in the software of the associated components). In any event, however, the central devices for mitigating software manipulation are separate from the associated components. The central device 25 for mitigating software manipulation may in some cases also be designed to mitigate manipulation of its own software and/or the software of a component in which the central device 25 for mitigating software manipulation is integrated.

In the example of FIG. 2, a plurality of components, for which manipulation of the software thereof can be remedied using the techniques of the present invention, comprise a plurality of control units 27a-f. As already described, the techniques of the present invention are limited to control units, but are in principle usable for any component of an on-board network of the vehicle 20. However, since control units 27a-f in vehicles often have only limited hardware resources and/or functionalities, the techniques of the present invention may in some cases be particularly advantageous for control units.

In FIG. 2, the control units 27a-f are subdivided into a plurality of domains 26a-n. The domains may be functional and/or local domains of the vehicle 20. A functional domain may comprise various components of a vehicle which participate in providing a specific vehicle function (e.g., engine/motor control, drive train control, infotainment, air conditioning, etc.). A local domain may comprise various components of a vehicle which are physically arranged in a specific region of the vehicle (e.g. “rear right”, “front left”, “front interior” etc.).

A domain 26-n may in turn contain a component 27a, 27d which acts as a central communication node for the respective domain 26a-n and/or assumes control functions for the respective domain 26a-n. In some examples, a central device for mitigating software manipulation may be part of component 27a, 27d which acts as a central communication node for the respective domain 26a-n and/or assumes control functions for the respective domain 26a-n. This central device for mitigating software manipulation may be provided in addition to further central devices for mitigating software manipulation (e.g. a central device for mitigating software manipulation as part of a central communication interface of the on-board network) or as a single central device for mitigating software manipulation (see explanations further above). Further alternatively or additionally, a central device for mitigating software manipulation may be designed as part of a central control unit 23 of the vehicle. Further alternatively or additionally, a central device for mitigating software manipulation may be arranged as part of a head unit of an infotainment system of the vehicle 20 (not shown in FIG. 2). Further alternatively or additionally, a central device for mitigating software manipulation may be arranged as part of a central computer (“vehicle computer”) of the on-board network (the on-board network may contain a plurality of central computers/“vehicle computers”). A central computer (“vehicle computer”) may have (considerably) higher performance than dedicated control units of the on-board network and assume the tasks of a plurality of control units (possibly in the plurality of the above-stated domains).

The vehicle 20 may further comprise a central persistent memory 41 (i.e., a memory which stores its information in the vehicle permanently, e.g. for longer than one day or longer than one week and/or during an idle state of the vehicle). In some examples, the persistent memory 41 may comprise a flash memory. In the example of FIG. 2, the persistent memory 41 is arranged in or directly connected to the central communication interface of the vehicle 20. As discussed, the central device 25 for mitigating software manipulation may likewise be arranged in the central communication interface of the vehicle 20. Even if a central device for mitigating software manipulation software is (additionally or alternatively) arranged in another component, a persistent memory may additionally or alternatively be arranged in the same component. In this way, the central device for mitigating software manipulation can make use of data stored in the persistent memory to mitigate manipulation. In other examples, a central device for mitigating software manipulation and a persistent memory may, however, also be arranged in different components of the on-board network (and the central device for mitigating software manipulation can access the persistent memory via the network).

The persistent memory 41 may be designed simultaneously to store software components 42a, 42c-n for each of the plurality of components 27a-f. The persistent memory 41 may to this end be designed with a storage capacity of more than 256 MB (preferably more than 5 GB).

The countermeasure against manipulation may comprise resetting the software of a component whose software has been identified as having undergone manipulation (also denoted “first component” in the present disclosure), using software components 42a, 42c-n for the respective component which are stored in the central persistent memory 41. Further aspects of this countermeasure are discussed below with reference to FIG. 3 and FIG. 4.

In some examples, the software components 42a, 42c-n present in the central persistent memory 41 may be based on software update information 32a, 32c-n for each of the plurality of components 27a-n (e.g. generated from or corresponding to the software update information 32a, 32c-n).

The software update information 32a, 32c-n may be received via an interface 21 of the vehicle 20. The interface 21 may be a wireless interface (as shown in FIG. 2) but in other examples also a wired interface (not shown in FIG. 2). The vehicle may be designed to receive software update information 32a, 32c-n from a remote system 30 via the interface 21. As shown in FIG. 1, the remote system 30 can select 107 the software update information 32a, 32c-n for the corresponding vehicle and send 109 it to the vehicle 20 via the interface 21. The remote system 30 may be any desired system which is suitable for providing software update information 32a, 32c-n (e.g. a cloud storage system and/or a distributed system). In addition to providing software update information 32a, 32c-n, the remote system 30 may assume further functions during vehicle operation (e.g. vehicle monitoring and/or control functions).

In some examples, the software update information 32a, 32c-n for a plurality of components (e.g. control units 27a, c-n) is contained in a software bundle or software container 31 (i.e., the software update information is provided in bundled form). The software bundle or software container 31 (frequently of considerable size) is transferred to the vehicle 20 at a specific point in time. As described, the transferred software update information 32a, 32c-n is used in the vehicle 20 for updating the software of the plurality of components 27a-f. For this purpose, the software update information 32a, 32c-n obtained from the remote system 30 may pass through one or more preparatory steps (e.g., unpacking, signature verification etc.).

Additionally or alternatively, software update information 32a, 32c-n (e.g., in a software bundle or software container) may also be received via a wired interface 22.

The software update information 32a, 32c-n may, before or after any preparatory steps, be stored in the persistent memory 41 as software components 42a, 42c-n for the plurality of components 27a, c-n (e.g. before it is used for updating the software of components 27a, c-n). The stored software components 42a, 42c-n for the plurality of components 27a, c-n are then available to the central device 25 for mitigating software manipulation in order to mitigate manipulation in the plurality of components 27a, c-n. This mitigation may proceed after completion of the software update for each of the plurality of components 27a, c-n (e.g., in a period of time until further software update information 32a, 32c-n is received).

In this manner, the techniques of the present invention may in some examples make use of components which are already present in the vehicle, e.g., a persistent memory 41 which is used in a updating process for the software of the vehicle 20. In some cases, this can result in considerable component savings (as described above, the memory required to store a software bundle or software container 31 of software update information 32a, 32c-n may be of considerable size). It is additionally or alternatively possible to avoid equipping the individual components with additional resources (e.g., memory), which can likewise reduce complexity and thus fault susceptibility and/or costs. Further additionally or alternatively, the information of the persistent memory 41 is quickly available in many situations independently of the usability of a communication channel of the vehicle. This can increase the response time of the manipulation mitigation procedure.

In the techniques of the present invention, the mitigation countermeasure may be performed substantially without assistance of systems external to the vehicle 20 (e.g. the remote system 30). For example, the countermeasure can be initiated by the central device 25 for mitigating software manipulation without any need for communication with systems external to the vehicle 20 (during this process, the vehicle 20 may very well communicate with a system external to the vehicle 20 for other purposes). Additionally or alternatively, the central device 25 for mitigating software manipulation (or another component of the on-board network) can perform a countermeasure without any need for communication with systems external to the vehicle 20.

In some examples (see step 105 in FIG. 1), the techniques of the present invention may comprise selecting the countermeasure from a plurality of countermeasures on the basis of context information for the vehicle. The context information may comprise information relating to an operating state of the vehicle 20 and/or relating to predetermined rules for operating the vehicle 20.

An operating state may be a driving state of the vehicle (e.g. driving quickly, driving slowly, performing specific driving maneuvers etc.), but also an operating state while the vehicle is not traveling. Alternatively or additionally, the context information for the vehicle 20 may be environment information and/or vehicle component status information.

The rules for operating the vehicle 20 may contain predetermined safety criteria (which may in turn depend on operating states of the vehicle 20 and for example define when and with what dependencies a countermeasure may be initiated for a specific component).

The context information may at least in part be stored in a memory of the central device 25 for mitigating software manipulation (e.g. the central persistent memory 41) for use in selecting a countermeasure (in particular that part of the context information which comprises information relating to predetermined rules for operating the vehicle 20). The context information can in some examples be updated from outside the vehicle 20 (e.g. as part of software update information 32b for the central device 25 for mitigating software manipulation or a component in which the central device 25 for mitigating software manipulation is arranged).

In some examples, various countermeasures may be available for mitigating specific manipulations of the software of components 27a, c-n (more on possible countermeasures below). The context information can now be used to select one of the available countermeasures. In some examples, the countermeasures selected from the plurality of available countermeasures may be those which allow a nominal state of the component to be restored to the greatest possible extent (i.e. which remedies the manipulation to the greatest possible extent). On the other hand, in some situations available countermeasures can be ruled out on the basis of rules contained in the context information (e.g. if a specific safety criterion would be violated).

For example, while a first countermeasure might indeed enable more thorough mitigation of the manipulation than a second countermeasure, it would on the other hand entail a more in-depth intervention in the vehicle components (and thus a greater risk of disruption which the mitigation process may itself cause). While a second countermeasure might indeed enable less thorough mitigation of the manipulation in comparison with the first countermeasure, it would on the other hand also entail a less in-depth intervention in the vehicle components. In this case, the first countermeasure may be selected in a first context (expressed by the context information) and the second countermeasure in a second context (expressed by the context information). In an illustrative example, the first context may be a context in which the vehicle is driving fast and the second context a context in which the vehicle is stationary. In other cases, the context information may comprise a safety criterion, compliance with which prohibits the performance of the first countermeasure in a first situation but permits it in a second situation.

In some examples, the countermeasures may comprise an immediate reset (e.g. within five minutes or within one minute) of the software of the first component 27a, c-f using software component 42a, c-n stored in the central persistent memory 41 (e.g. generated on the basis of the received software update information) for component 27a, c-f, for which manipulation has been identified and a later reset of the software of component 27a, c-f using software components 42a, c-n for the respective component 27a, c-f. Again, an immediate reset may be ruled out in specific contexts (e.g. by safety criteria). For example, the later reset may occur in a period of time until the next start-up process of the respective component 27a, c-f.

Further aspects of the techniques of the present invention are explained below with reference to FIG. 3 and FIG. 4. FIG. 3 shows the on-board network according to FIG. 2 in which a first component 27c has been manipulated. FIG. 4 shows the on-board network according to FIG. 2 in which the manipulation of the first component 27c has been remedied.

Firstly, some aspects of detecting manipulation of the software of a component 27a, c-f of the vehicle 20 are explained in greater detail. As mentioned above, the techniques of the present invention include identifying a possibility of manipulation of the software of a component of a plurality of components of an on-board network, which in some examples includes receiving a signal. This signal can be generated in various ways.

Firstly, manipulation of software of a component 27a, c-f may be detected. This detection may proceed locally by appropriate (manipulation) detection devices of the corresponding component.

In FIG. 3, the software of one of the control units 27c (the “first component” in some examples of the present disclosure) has been manipulated. A manipulated software component 71 was introduced.

A (manipulation) detection device 81a of the control unit 27c can identify this manipulation and generate a corresponding signal for the central device 25 for mitigating software manipulation (see also steps 111 and 113 in FIG. 1). This signal can then be processed as discussed above to initiate mitigation.

In other examples or in addition, a (manipulation) detection device 61b of the central communication interface of the vehicle 20 can detect manipulation of the control unit 27c (remotely) and generate the signal for the central device 25 for mitigating software manipulation (which in the example of FIG. 3 is likewise arranged in the central communication interface of the vehicle 20). In some examples, the central device 25 for mitigating software manipulation is thus also designed for central detection of the manipulation of the software of a plurality of components 27a, c-f of the on-board network.

In other examples or in addition, a detection device of the remote system 30 can (remotely) detect manipulation of the control unit 27c and generate the signal for the central device 25 for mitigating software manipulation. In this example, the signal can be received via an interface of the vehicle. However, if manipulation detection also takes place within the vehicle, it is in some cases possible to shorten a period of time until the manipulation is mitigated.

The various detection devices 81a, 61b (in particular the detection devices 81a, 61b arranged in the vehicle) may be detection devices which are already present in the (on-board) network. As described above, software manipulation can also be identified in some conventional methods.

Manipulation can be detected in any possible manner. For example, software can be checked on start-up (“secure boot)” and/or during operation (“run-time manipulation detection”) by means of one or more methods for checking the authenticity and/or integrity of the software (e.g. using one or more digital signatures).

In other examples, a signal, the absence of which identifies the possibility of manipulation, can be generated by the components described in the preceding paragraphs. For example, a (manipulation) detection device 81a of the control unit 27c can generate a signal (e.g., periodically or on the occurrence of specific events), the absence of which may indicate manipulation of the software of the control unit 27c.

Further aspects of the countermeasure of resetting the software of the first component 27c using a software component 42c for the first component 27c stored in the central persistent memory 41 will now be discussed with reference to FIG. 3 and FIG. 4.

The central device 25 for mitigating manipulation can select a countermeasure on the basis of manipulation of the first component 27c having been detected. In the example of FIG. 3 and FIG. 4, the countermeasure selected is resetting the software of the first component 27c. Resetting may comprise restoring the software to its most recently authenticated state. This may comprise deleting and/or overwriting parts or the entirety of the software of the first component 27c (e.g. a control unit). Deletion and/or overwriting of parts or the entirety of the software of the first component 27c may be performed remotely by the central device 25 for mitigating manipulation (i.e. via a connection of the on-board network). In this manner, the manipulated software component 71, or parts thereof 81a, 81b can be replaced with an authentic (i.e. unmanipulated) software component 52c, or parts thereof 53a, 53b in order to remedy the manipulation.

The authentic (i.e. unmanipulated) software 52c may thus be retrieved from the persistent memory 41. As already mentioned, the persistent memory 41 may store the software component 42c in a directly usable form or in a form which can only be used after one or more processing steps for resetting the manipulated software component 71 of the first component 27c.

In some examples, the central device 25 for mitigating manipulation can perform measures to ensure the authenticity of the software components 42a, c-n used for resetting the software of the components. For example, an authenticity check may be performed (e.g. on the basis of a digital signature or another security feature) before one of the software components 42a, c-n is used. The central device 25 for mitigating manipulation may make use of functionalities of the component in which the central device 25 for mitigating manipulation is integrated for the authenticity check.

In some examples, the persistent memory 41 may contain more than one version of a software component for a specific component of the on-board network. In this case, the central device 25 for mitigating manipulation can select one of the versions (e.g. a current version of the software component).

The previous section discussed a countermeasure for mitigating manipulation of a first component 27c of the on-board network with reference to FIG. 3 and FIG. 4. The central device 25 for mitigating manipulation is however set up to initiate countermeasures with regard to manipulation of the software of one or more further components of the plurality of components 27a, d-f at another point in time from or simultaneously with the mitigation of the manipulation of the software of the first component 27c.

In some examples, the central device 25 for mitigating manipulation is designed to identify the possibility of manipulation of the software of a further component 27a, d-f of the plurality of components of the on-board network and initiate a further countermeasure for mitigating the manipulation of the further component 27a, d-f. Manipulation can be detected and countermeasures initiated as described above. For example, a manipulated software component of the further component 27a, d-f may be reset.

In this manner, a single central device for mitigating manipulation can service (i.e. remedy manipulation of software of the plurality of components) a plurality of components remote from it in the on-board network (e.g. control units in various domains).

The preceding sections described resetting software of a component as an exemplary countermeasure which is initiated (and in some cases performed) by the central device for mitigating manipulation.

In some examples, the central device for mitigating manipulation may alternatively or additionally initiate (and in some examples perform) other countermeasures.

In some examples, the countermeasure against manipulation may comprise blocking communication of the first component 27c (whose software has been manipulated) via the on-board network. Blocking communication may prevent manipulated software of the first component 27c causing damage via the on-board network. On the other hand, manipulated software can still (e.g. for a certain period of time) perform a function of the first component 27c. For this reason, blocking communication of the first component 27c via the on-board network may in some cases be preferred to resetting the software of the first component 27c (e.g. in a context in which failure of the first component 27c is not tolerable or desirable, at least in the short term).

The countermeasure of resetting the software of the first component 27c can be initiated subsequent to the countermeasure of blocking communication of the first component 27c (e.g. in a changed context).

Alternatively or additionally, the countermeasure against manipulation may comprise blocking communication of a group of components, which contains the first component 27c, via the on-board network. In the example of FIG. 3, the first component 27c may be present with further components 27a, b in a first domain 26a. Blocking communication of a group of components via the on-board network is similar to blocking the individual component as described above. In this case too, it is possible to prevent the group of components from causing damage in the on-board network. Also in the case of blocking communication of a group of components via the on-board network, the countermeasure of resetting the software of the first component 27c can be initiated at a later point in time (e.g. in a changed context).

Further alternatively or additionally, the countermeasure against manipulation may comprise modifying a functionality of the first component 27c, for which manipulation has been identified. For example, a functionality can be restricted according to a predetermined pattern (e.g. to a functionality which is used for specific safety-relevant aspects in a respective context).

Further alternatively or additionally, the countermeasure against manipulation may comprise displacing a functionality of the first component 27c, for which manipulation has been identified, to one or more other components of the plurality of components 27a, b, d-f. For example, the one or more of the other components of the plurality of components 27a, b, d-f a can at least temporarily assume a task (or parts thereof) of the first component 27c. The first component 27c can then be disabled and/or blocked. In this case too, the countermeasure of resetting the software of the first component 27c can be initiated at a later point in time (e.g. in a changed context).

The techniques of the present invention have been described many times in the preceding sections with reference to the respective methods. However, the present invention also relates to a central device for mitigating manipulation of software of a plurality of components of an on-board network of a vehicle, which is designed to carry out the steps of methods of the present invention. As described above, the central device for mitigating software manipulation may be a standalone device (i.e., a dedicated module with its own hardware and software resources which is part of the on-board network and can communicate with the other components of the on-board network). However, in other cases, the central device for mitigating software manipulation is integrated into another (already present) component of the on-board network. The central device for mitigating software manipulation may here take the form of a software module (which is inserted into the software of the component). In other cases, the central device for mitigating software manipulation may have at least some dedicated hardware components (while making joint use of other hardware components of the component into which it is integrated). As likewise mentioned, the other component may be a central communication interface of the on-board network, a central computer (“vehicle computer”) or another component with comparatively higher performance hardware.

In some examples, an existing component of the on-board network (e.g. a central communication interface of the vehicle or a domain of the vehicle, or a central computer of the vehicle, or a head unit of an infotainment system) can be set up as a central device for mitigating software manipulation by updating the software of the component of the on-board network.

The central device for mitigating software manipulation or the other component in which it is integrated may comprise at least one processor (optionally with a plurality of cores) and memory which comprises instructions which, when executed by the processor, carry out the steps of the method of the present invention.

The present invention furthermore relates to an on-board network for a vehicle which comprises at least one central device for mitigating software manipulation according to the present invention and a plurality of components of the on-board network.

The central device for mitigating software manipulation can in some cases detect manipulation of the software of the plurality of components and initiate countermeasures (as described above).

The present invention further relates to a vehicle which comprises an on-board network according to the present invention.

The present invention further relates to a computer program which is designed to carry out the method of the present invention.

The present invention further relates to a computer-readable medium (e.g., a DVD or a solid-state storage device) which contains a computer program of the present invention.

The present invention further relates to a signal (e.g. an electromagnetic signal according to a wireless or wired communication protocol) which codes a computer program of the present invention.

1-14. (canceled)

15. A computer-implemented method, comprising the following steps:
identifying a possibility of manipulation of software of a first component of a plurality of components of an on-board network of a vehicle in a central device for mitigating software manipulation, wherein the central device for mitigating manipulation is part of the on-board network and is configured to mitigate manipulation of software in each of the plurality of components of the on-board network; and
initiating a countermeasure for mitigating manipulation of the software of the first component by the central device for mitigating manipulation.

16. The method as recited in claim 15, wherein the countermeasure against manipulation includes resetting the software of the first component using a software component for the first component stored in a central persistent memory, wherein the central persistent memory is configured to simultaneously store software components for each of the plurality of components.

17. The method as recited in claim 16, further comprising:
receiving software update information for each of the plurality of components in the vehicle;
updating software of each of the plurality of components using the software update information; and
storing the software update information in the persistent memory for use by the central device for mitigating manipulation, after completion of the software update for each of the plurality of components, to form the software components for each of the plurality of components.

18. The method as recited in claim 15, wherein the mitigation countermeasure is performed substantially without assistance of systems external to the vehicle.

19. The method as recited in claim 15, further comprising:
selecting the countermeasure from a plurality of countermeasures based on context information for the vehicle.

20. The method as recited in claim 19, wherein the context information contains information relate to an operating state of the vehicle and/or relates to predetermined rules for operating the vehicle.

21. The method as recited in claim 19, wherein the countermeasure includes immediately resetting the software of the first component using software components for the first component stored in a central persistent memory, and subsequently resetting the software of the first component using software components for the first component.

22. The method as recited in claim 15, wherein the countermeasure includes one or more of:
blocking communication of the first component via the on-board network;
blocking communication of a group of the components, which contains the first component, via the on-board network;
modifying a functionality of the first component and/or displacing a functionality of the first component to one or more others of the plurality of the components.

23. The method as recited in claim 15, further comprising:
identifying manipulation of the software of the first component by a manipulation detection device of the central device for mitigating manipulation or a further component of the on-board network; and
generating a signal which indicates manipulation of the software of the first component of the plurality of components of the on-board network;
wherein the identifying of the possibility of manipulation proceeds based on the signal which indicates manipulation of the software of the first component of the plurality of components of the on-board network.

24. The method as recited in claim 15, wherein:
the plurality of components of the on-board network includes one or more control units; and/or
the first component is a control unit.

25. A central device for mitigating manipulation of software of a plurality of components of an on-board network of a vehicle, the central device configured to:
identify a possibility of manipulation of software of a first component of the plurality of components of the on-board network of the vehicle in the central device for mitigating software manipulation, wherein the central device for mitigating manipulation is part of the on-board network and is configured to mitigate manipulation of software in each of the plurality of components of the on-board network; and
initiate a countermeasure for mitigating manipulation of the software of the first component by the central device for mitigating manipulation.

26. An on-board network for a vehicle, comprising:
a plurality of components of the on-board network; and
a central device for mitigating manipulation of software of the plurality of components, the central device configured to:
identify a possibility of manipulation of software of a first component of the plurality of components of the on-board network of the vehicle in the central device for mitigating manipulation, wherein the central device for mitigating manipulation is part of the on-board network and is configured to mitigate manipulation of software in each of the plurality of components of the on-board network, and
initiate a countermeasure for mitigating manipulation of the software of the first component by the central device for mitigating manipulation.

27. A vehicle, comprising:
an on-board network for a vehicle, including:
a plurality of components of the on-board network; and
a central device for mitigating manipulation of software of the plurality of components, the central device configured to:
identify a possibility of manipulation of software of a first component of the plurality of components of the on-board network of the vehicle in the central device for mitigating manipulation, wherein the central device for mitigating manipulation is part of the on-board network and is configured to mitigate manipulation of software in each of the plurality of components of the on-board network, and
initiate a countermeasure for mitigating manipulation of the software of the first component by the central device for mitigating manipulation.

28. A non-transitory computer-readable medium on which is stored a computer program, the computer program, when executed by a computer, causing the computer to perform:
identifying a possibility of manipulation of software of a first component of a plurality of components of an on-board network of a vehicle in a central device for mitigating software manipulation, wherein the central device for mitigating manipulation is part of the on-board network and is configured to mitigate manipulation of software in each of the plurality of components of the on-board network; and
initiating a countermeasure for mitigating manipulation of the software of the first component by the central device for mitigating manipulation.
